(19) United States
(12) Patent Application Publication
(10) Pub. No.: US 2024/0340914 A1
(43) Pub. Date: Oct. 10, 2024

(54) METHOD, USER EQUIPMENT, AND BASE STATION FOR BEAM INDICATION IN AN MTRP OPERATION

(71) Applicant: FG Innovation Comany Limited, Tuen Mun (HK)

(72) Inventors: WAN-CHEN LIN, Taipei (TW); Mei-Ju Shih, Taipei (TW); Chia-Hung Lin, Taipei (TW)

(21) Appl. No.: 18/625,915

(22) Filed: Apr. 3, 2024

Related U.S. Application Data
(60) Provisional application No. 63/457,436, filed on Apr. 6, 2023.

(51) Int. Cl. H04W 72/231; H04W 16/28; H04W 72/1273; H04W 76/20

(52) U.S. Cl. CPC H04W 72/231; H04W 16/28; H04W 72/1273; H04W 76/20

(57) ABSTRACT

A method performed by a UE for beam indication in a multiple transmission and reception point (mTRP) operation is provided. The method receives, from a BS, a radio resource control (RRC) configuration for configuring a set of transmission configuration indication (TCI) states. The method receives, from the BS, a medium access control (MAC) control element (CE) that activates one or more TCI states from the set of TCI states. The method receives, from the BS, a downlink control information (DCI) format that includes a TCI selection field indicating a relationship between the activated one or more TCI states and one or more TRPs. The method performs, based on the TCI selection field, a physical downlink shared channel (PDSCH) reception.

### CROSS-REFERENCE TO RELATED APPLICATION(S)

The present disclosure claims the benefit of and priority to U.S. Provisional Patent Application Ser. No. 63/457,436, filed on Apr. 6, 2023, entitled “METHOD AND APPARATUS FOR DEFAULT INDICATION IN UNIFIED TCI FRAMEWORK,” the content of which is hereby incorporated herein fully by reference into the present disclosure for all purposes.

### FIELD

The present disclosure is related to wireless communication and, more specifically, to a method, a user equipment (UE), and a base station (BS) for beam indication in a multiple transmission and reception point (mTRP) operation in cellular wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there is a need for further improvements in wireless communications in the next-generation wireless communication systems.

### SUMMARY

The present disclosure is related to a method, a user equipment (UE), and a base station (BS) for beam indication in a multiple transmission and reception point (mTRP) operation in cellular wireless communication networks.

In a first aspect of the present application, a method performed by a UE for beam indication in a multiple transmission and reception point (mTRP) operation is provided. The method includes receiving, from a BS, a radio resource control (RRC) configuration for configuring a set of transmission configuration indication (TCI) states; receiving, from the BS, a medium access control (MAC) control element (CE) that activates one or more TCI states from the set of TCI states; receiving, from the BS, a downlink control information (DCI) format that includes a TCI selection field indicating a relationship between the activated one or more TCI states and one or more TRPs; and performing, based on the TCI selection field, a physical downlink shared channel (PDSCH) reception.

In an implementation of the first aspect, in a case that the DCI format does not further include a TCI field indicating one or more TCI states from the activated one or more TCI states, the TCI selection field further indicates that the activated one or more TCI states correspond to a first TRP, a second TRP, or both the first TRP and the second TRP.

In another implementation of the first aspect, the TCI selection field includes a first codepoint, a second codepoint, or a third codepoint, the first codepoint indicates that a first activated TCI state of the activated one or more TCI states corresponds to a first TRP, the first activated TCI state has a lowest index among indices of the activated one or more TCI states, the second codepoint indicates that a second activated TCI state of the activated one or more TCI states corresponds to a second TRP, the second activated TCI state has a second lowest index among indices of the activated one or more TCI states, and the third codepoint indicates that the first activated TCI state and the second activated TCI state of the activated one or more TCI states correspond, respectively, to the first TRP and the second TRP.

In another implementation of the first aspect, in a case that the DCI format further includes a TCI field indicating one or more TCI states from the activated one or more TCI states, the TCI selection field further indicates that the indicated one or more TCI states correspond to a first TRP, a second TRP, or both the first TRP and the second TRP.

In another implementation of the first aspect, each TCI state of the set of TCI states includes a joint TCI state.

In another implementation of the first aspect, each TCI state of the set of TCI states includes a downlink (DL) TCI state.

In another implementation of the first aspect, the DCI format includes a DCI format 1_1 or a DCI format 1_2.

In a second aspect of the present application, a UE for beam indication in an mTRP operation is provided. The UE includes one or more processors; and at least one non-transitory computer-readable medium coupled to the one or more processors, and storing one or more computer-executable instructions that, when executed by the one or more processors, cause the UE to receive, from a BS, a radio resource control (RRC) configuration for configuring a set of transmission configuration indication (TCI) states; receive, from the BS, a medium access control (MAC) control element (CE) that activates one or more TCI states from the set of TCI states; receive, from the BS, a downlink control information (DCI) format that includes a TCI selection field indicating a relationship between the activated one or more TCI states and one or more TRPs; and perform, based on the TCI selection field, a physical downlink shared channel (PDSCH) reception.

In a third aspect of the present application, a BS for beam indication in an mTRP operation is provided. The BS includes one or more processors; and at least one non-transitory computer-readable medium coupled to the one or more processors, and storing one or more computer-executable instructions that, when executed by the one or more processors, cause the BS to transmit, to a UE, a radio resource control (RRC) configuration for configuring with the UE a set of transmission configuration indication (TCI) states; transmit, to the UE, a medium access control (MAC) control element (CE) that activates one or more TCI states from the set of TCI states; transmit, to the UE, a downlink control information (DCI) format that includes a TCI selection field indicating a relationship between the activated one or more TCI states and one or more TRPs; and perform, based on the TCI selection field, a physical downlink shared channel (PDSCH) transmission.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart/process illustrating a method for performed by a UE for beam indication in an mTRP operation, according to an example implementation of the present disclosure.

FIG. 2 is a flowchart/process illustrating a method performed by a BS for beam indication in an mTRP operation, according to an example implementation of the present disclosure.

FIG. 3 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AL | Aggregation level |
| BFD | Beam Failure Detection |
| BWP | Bandwidth Part |
| CA | Carrier Aggregation |
| CORESET | Control Resource Set |
| CC | Component Carrier |
| CCE | Control Chanel Element |
| CJT | Coherent Joint Transmission |
| CRC | Cyclic Redundancy Check |
| C-RNTI | Cell-Radio Network Temporary Identifier |
| CS-RNTI | Configured Scheduling-Radio Network Temporary |
| | Identifier |
| CSS | Common Search Space |
| CSI | Channel State Information |
| DC | Dual Connectivity |
| DCI | Downlink Control Information |
| DL | Downlink |
| FDM | Frequency Division Multiplexing |
| GC-PDCCH | Group Common-Physical Downlink Control Channel |
| HARQ | Hybrid Automatic Repeat Request |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| MAC | Medium Access Control |
| MAC CE | MAC Control Element |
| MCG | Master Cell Group |
| MCS-C-RNTI | Modulation Coding Scheme-Cell-Radio Network |
| | Temporary |
| | Identifier |
| mTRP | Multiple Transmission Reception Point |
| MIMO | Multiple-input Multiple-output |
| MSB | Most Significant Bit |
| NACK | Negative Acknowledgment |
| NDI | New Data Indicator |
| NR | New RAT/Radio |
| NW | Network |
| PCI | Physical Cell ID |
| PCell | Primary Cell |
| PSCell | Primary Secondary Cell |
| PBCH | Physical Broadcast Channel |
| PDCCH | Physical Downlink Control Channel |
| PDSCH | Physical Downlink Shared Channel |
| PDU | Protocol Data Unit |
| PHY | Physical (layer) |
| PRACH | Physical Random Access Channel |
| PTAG | Primary Timing Advance Group |
| PUCCH | Physical Uplink Control Channel |
| PUSCH | Physical Uplink Shared Channel |
| RA | Random Access |
| RAN | Radio Access Network |
| RAR | Random Access Response |
| Rel | Release |
| RMSI | Remaining Minimum System Information |
| RNTI | Radio Network Temporary Identifier |
| RRC | Radio Resource Control |
| RRM | Radio Resource Management |
| RS | Reference Signal |
| RSRP | Reference Signal Received Power |
| RV | Redundancy Version |
| SCell | Secondary Cell |
| SCG | Secondary Cell Group |
| SCS | Subcarrier Spacing |
| SDM | Spatial Division Multiplexing |
| SFN | Single Frequency Network |
| SINR | Signal to Interference plus Noise Ratio |
| SpCell | Special Cell |
| SR | Scheduling Request |
| SRI | SRS resource indicator |
| SRS | Sounding Reference Signal |
| SSB | Synchronization Signal Block |
| STAG | Secondary Timing Advance Group |
| STxMP | Simultaneous Transmission on Multiple Panels |
| SUL | Supplementary UL |
| TA | Timing Advance |
| TAG | Timing Advance Group |
| TB | Transport Block |
| TBS | Transport Block |
| TCI | Transmission Configuration Indication |
| TDM | Time Division Multiplexing |
| TPMI | Transmission Precoding Matrix Indicator |
| TR | Technical Report |
| TRP | Transmission Reception Point |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WG | Working Group |
| WI | Working Item |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

Descriptions of some selected terms in the present disclosure are provided as follows.

Antenna Panel: A conceptual term for the UE antenna implementation. It may be assumed that a panel is an operational unit for controlling a transmission spatial filter (e.g., a beam). A panel may typically include multiple antenna elements. In some implementations, a beam may be formed by a panel. To form two beams simultaneously, two panels may be needed. Such simultaneous beamforming from multiple panels may be subject to a UE's capability (which may also be referred to as UE capability in this disclosure). A similar definition for “panel” may be applicable by applying spatial receiving filtering characteristics.

BWP: A subset of the total cell bandwidth of a cell may be referred to as a bandwidth part (BWP), and beamwidth part adaptation may be achieved by configuring the UE with one or more BWPs and informing the UE of which of the configured BWPs is currently active. To enable bandwidth adaptation (BA) on the PCell, the gNB may configure the UE with both UL and DL BWPs. To enable BA on the SCells in the case of carrier aggregation (CA), the gNB may configure the UE with at least DL BWP(s) (e.g., there may be no BWP in the UL). For the PCell, the initial BWP may be the BWP used for an initial access. For the SCell(s), the initial BWP may be the BWP configured for the UE to first operate upon an SCell activation. The UE may be configured with a first active uplink BWP by an information element (IE), such as the firstActiveUplinkBWP IE. If the first active uplink BWP is configured for an SpCell, the firstActiveUplinkBWP IE field may include the ID of the UL BWP to be activated upon performing the RRC (re-) configuration. If such an IE field is absent, the RRC (re-) configuration may not impose a BWP switching. If the first active uplink BWP is configured for an SCell, the firstActiveUplinkBWP IE field may include the ID of the uplink bandwidth part to be used upon a MAC activation of an SCell.

TCI state: A TCI state may include parameters for configuring a QCL relationship between one or two reference signals and a target reference signal set. For example, a target reference signal set may include the Demodulation Reference Signals (DM-RS) ports of a PDSCH, a PDCCH, a PUCCH, or a PUSCH. The one or two reference signals may include either UL or DL reference signals. In NR Rel-15/16, the TCI state may be used for a DL QCL indication, while the spatial relation information may be used to provide UL spatial transmission filter information for the UL signal(s) or the UL channel(s). In this disclosure, a TCI state may be referred to as information similar to spatial relation information, which could be used for UL transmission. In other words, from a UL's perspective, a TCI state may provide the UL beam information, which may include the information for a relationship between a UL transmission and a DL or one or more UL reference signals (e.g., CSI-RS, SSB, SRS, PTRS).

Panel: the UE panel information may be derived from the TCI state/UL beam indication information or the network signaling.

Beam: The term “beam” may be interpreted as a spatial filter. For example, when a UE reports a preferred gNB transmission (TX) beam, the UE may be essentially selecting a spatial filter used by the gNB. The term “beam information” may include information about which beam/spatial filter is being used/selected.

MIMO may be a key technology in NR systems, achieving success in commercial deployments. It may be important to identify and specify necessary enhancements for the uplink MIMO. Additionally, enhancements to the downlink MIMO may be needed to facilitate the use of large antenna arrays for both FR1 and FR2, meeting the demands for the evolution of NR deployments. Moreover, the concept of Multiple Transmission Reception Point (mTRP) has been introduced to enhance massive MIMO. The mTRP operation may improve reliability, coverage, and capacity performance through flexible deployment scenarios, allowing the base stations to communicate with the UEs via the mTRP for more accurate data transmission.

To support MIMO techniques, a TCI state from the gNB may provide beam information to a UE, ensuring a common understanding of the applied beam. One or more TCI states may be configured by RRC signaling, and a subset of the configured one or more TCI states may be activated via a MAC CE. If multiple TCI states are activated, a DCI field may indicate the applied TCI state to the corresponding channels/reference signals. However, the absence of a DCI field may create ambiguity about the application of the TCI state when multiple TCI states are activated, necessitating a default behavior for the beam indication. Thus, the present disclosure may provide a method and apparatus for default TCI indication within a unified TCI framework.

When a DCI format (e.g., DCI format 1_1 or DCI format 1_2) with at least one DCI field is used to indicate one or more TCI states for a UE, the UE may apply the indicated one or more TCI states to all PDSCH DMRS ports of the corresponding PDSCH transmission occasion(s) scheduled/activated by the DCI format. When a DCI format (e.g., DCI format 0_1 or DCI format 0_2) with at least one DCI field is used to indicate one or more TCI states for a UE, the UE may apply the indicated one or more TCI states to all the PUSCH antenna ports of the corresponding PUSCH transmission occasion(s) scheduled/activated by the DCI format. A DCI field (e.g., a first DCI field) may be used to indicate one or more TCI states (e.g., a first TCI state and a second TCI state), while another DCI field (e.g., a second DCI field) may be used to indicate which indicated TCI state is applied (e.g., the indicated first TCI state is applied, the indicated second TCI state is applied, or both of the indicated first TCI state and the indicated second TCI state are applied). The DCI field (e.g., the first DCI field) may correspond to a TCI field, and another DCI field (e.g., the second DCI field) may correspond to a TCI selection field.

The multi-TRP (mTRP) may be a feature that enables a gNB to communicate with a UE using more than one TRP to ensure the reliability. Moreover, same data stream(s) from multiple TRPs may be transmitted/received with, at least, the ideal backhaul, and different data streams from multiple TRPs may be transmitted/received with both ideal and non-ideal backhauls. The ideal backhaul may enable a single DCI carried in a PDCCH from one TRP scheduling the data transmission/information from or to multiple TRPs (e.g., single-DCI-based multi-TRP/panel transmission) and the non-ideal backhaul may require more than one DCI carried in PDCCHs to schedule the data transmission/information corresponding to each TRP (e.g., multi-DCI-based multi-TRP/panel transmission). To enhance system reliability, at least one multi-TRP scheme may be applied to at least one channel/reference signal (e.g., a multi-TRP-based PDSCH operation, a multi-TRP-based PDCCH operation, a multi-TRP-based PUCCH operation, and a multi-TRP-based PUSCH operation).

TDM-based PDCCH repetition: Two PDCCHs with the same DCI format, DCI payload, same number of CCEs, and same number of candidates for each AL in two search spaces associated with two CORESETs may be linked to each other.

TDM-based PDSCH repetition: Inter-slot-based PDSCHs with same TB or intra-slot-based PDSCHs with same TB may correspond to different TRPs. The inter-slot-based PDSCHs may correspond to each repetitive PDSCH in each slot, and the intra-slot-based PDSCHs may correspond to multiple repetitive PDSCHs within a slot.

TDM-based PUCCH repetition: Inter-slot-based PUCCH transmissions in response to the corresponding PDSCH and intra-slot-based PUCCH transmissions in response to the corresponding PDSCH may be with the same UCI content corresponding to different beams for all PUCCH formats in time manners. The inter-slot-based PUCCH transmissions may correspond to each repetitive PUCCH in each slot, and the intra-slot-based PUCCH transmissions may correspond to each repetitive PUCCH within a slot.

TDM-based PUSCH repetition: Inter-slot-based PUSCH transmissions with same TB or intra-slot-based PUSCHs with same TB may correspond to different TRPs. The slot-based PUSCHs may correspond to each repetitive PUSCH in each slot, and the non-slot-based PUSCHs may correspond to multiple repetitive PUSCHs within a slot.

FDM-based repetition: Channels carrying same TB may correspond to two TCI states for a non-overlapped frequency resource allocation within a slot.

Multi-DCI-based scheme: Each DCI from two PDCCHs in separate search space associated with different CORESET pool index value may schedule its corresponding data streams/channels.

SFN-based PDCCH scheme: A CORESET corresponding to single frequency may be associated with two different beams.

SFN-based PDSCH scheme: A PDSCH corresponding to single frequency may be associated with two different beams.

SFN-based PUSCH scheme: A PUSCH corresponding to single frequency may be associated with two different beams.

SFN-based PUCCH scheme: A PUCCH corresponding to single frequency may be associated with two different beams.

SDM-based PDSCH: A PDSCH may be scheduled by DCI indicating two TCI states and may be associated with CDM groups without data of values 1,2, and 3 referring to CDM groups {0}, {0,1}, {0,1,2}, respectively.

SDM-based PUSCH: At least two PUSCHs with overlapped time resource and frequency resource may correspond to two different beams.

Coherent Joint Transmission (CJT) scheme: It may be assumed that the network has knowledge about the detailed channels to the UE from the two or more points. Up to two TCI states may be indicated to CJT-based UL transmissions/DL receptions in a BWP/CC.

A UE may be configured with a list including up to M TCI state configurations, and each TCI state may include parameters for configuring at least one quasi co-location (QCL) relationship between one or two downlink reference signals and the DM-RS ports of the PDSCH, the DM-RS port of PDCCH, or the CSI-RS port(s) of a CSI-RS resource. The UL TCI states may include parameters for providing one or two RSs (e.g., SSBs, CSI-RSs, and/or SRSs) for determining the UL transmission spatial filter for the UL transmissions (e.g., CG PUSCHs, DG PUSCHs, and/or SRSs).

The QCL types corresponding to each DL RS may be provided by the higher layer (e.g., an RRC layer) parameters for the at least one RS. The QCL types may include:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

A UE may be configured with a TCI state configuration including parameters for determining the UL TX spatial filter for the UL transmissions. More specifically, when the signals that are transmitted from different antenna ports share similar properties, the antenna ports may be determined to be QCL signals. The QCL concept is introduced to help the UE with precise channel estimation, frequency offset error estimation, and synchronization procedures. There may be three types of TCI states, which include the UL TCI states, the DL TCI states, and the joint TCI states, for the unified TCI framework.

To facilitate more efficient (e.g., lower latency and overhead) DL/UL beam management to support a larger number of configured TCI states, a unified TCI framework for beam indication may results in low complexity and/or simplified controlling mechanisms. More specifically, through the unified indication, the DL or UL channels/signals may share the same indicated TCI state to reduce signaling overhead, and different channels and/or reference signals may share similar channel properties. The unified indication may be used to indicate a common TCI state for the DL channels (e.g., including the PDCCH, the PDSCH, and/or the DL reference signal), a common TCI state for the UL channels (e.g., including the PUCCH, the PUSCH, and/or the UL reference signal), and/or a common TCI state for both the DL and UL channels. For example, the common TCI state for the DL channels/UL channels may be referred to as a scheme configured as ‘separate’ (e.g., the DL TCI state or the UL TCI state), and the common TCI state for both the DL and UL channels may be referred to as a scheme configured as ‘joint’ (e.g., the joint TCI state).

For a UE, to receive or transmit data from or to different TRPs associated with different cells (e.g., including both serving and non-serving cells), may not only benefit the maintenance of signaling but also may aid the reliability enhancement.

The inter-cell beam management may be indicated to a UE via a pre-configuration, a configuration, RRC signaling, DCI, or a MAC CE. Additionally, a UE's capability to support the inter-cell beam management may be reported. The multi-DCI scheme may be used to indicate the beam information corresponding to a cell which may be different from the serving cell. For example, the DCI corresponding to a CORESETPoolIndex may be used to indicate a beam for the serving cell and the DCI corresponding to another CORESETPoolIndex may be used to indicate a beam for the cell which may be different from the serving cell. To inform the UE of which cell the TRP is associated with, the indicator with an additional PCI index in a TCI configuration may be used to indicate that a TCI state/QCL information includes an additional PCI different from the serving cell PCI.

A set of additional PCI indices may include a set of PCI values mapping to a set of indices, and the additional PCI may include a list of information for the additional SSB with a PCI that is different from the serving cell PCI. It should be noted that the TCI configuration may include a DL TCI configuration (e.g., a list of TCI states for the DL channels/RSs), a UL TCI configuration (e.g., a list of TCI states for the UL channels/RSs), a unified TCI configuration (e.g., a list of TCI states for both the DL and UL channels/RSs), and/or a list of TCI states associated with a PDSCH, a CORESET, a PDCCH, an SSB, a CSI-RS, a UL power control, a UL pathloss RS, a PRACH, a PUSCH, an SRS, a PUCCH, a BWP, and/or a serving cell configuration.

In a DCI format or in different DCI formats, when one DCI field for indicating at least one TCI state is absent, and one other DCI field for selecting at least one TCI state to be applied is present, one or more of the following implementations in the present disclosure, but not limited to, may be applied. In a DCI format or in different DCI formats, when one DCI field for indicating at least one TCI state is present, and one other DCI field for selecting at least one TCI state to be applied is absent, one or more of the following implementations in the present disclosure, but not limited to, may be applied. In a DCI format or in different DCI formats, when one DCI field for indicating at least one TCI state is absent, and one other DCI field for selecting at least one TCI state to be applied is absent, one or more of the following implementations in the present disclosure, but not limited to, may be applied.

When an RRC parameter for configuring at least one TCI state is present, and one other RRC parameter for configuring which TCI state is to be applied is absent, one or more of the following implementations in the present disclosure, but not limited to, may be applied. When an RRC parameter for configuring at least one TCI state is absent, and one other RRC parameter for configuring which TCI state is to be applied is absent, one or more of the following implementations in the present disclosure, but not limited to, may be applied. When an RRC parameter for configuring at least one TCI state is present, a MAC CE for activating at least one TCI state is absent, a DCI field for indicating at least one TCI state is absent, and an RRC parameter for configuring which TCI state is to be applied is present, one or more of the following implementations in the present disclosure, but not limited to, may be applied. When an RRC parameter for configuring at least one TCI state exists, a MAC CE for activating at least one TCI state is absent, a DCI field for indicating at least one TCI state is absent, and a DCI field for selecting at least one TCI state to be applied is present, one or more of the following implementations in the present disclosure, but not limited to, may be applied.

In some implementations, the indicated at least one TCI state may include the TCI state for the serving cell. In some implementations, the indicated at least one TCI state may include the TCI state for the cell which is different from the serving cell. In some implementations, the indicated at least one TCI state may include the DL TCI state, the UL TCI state, and/or the joint TCI state.

When the number of configured TCI states via the RRC message is more than one, and the number of activated TCI states via the MAC CE is more than one, one or more of the following implementations in the present disclosure, but not limited to, may be applied. When the number of configured TCI states via the RRC message for each TRP is more than one, one or more of the following implementations in present disclosure, but not limited to, may be applied. When the number of activated TCI states via the MAC CE for each TRP is more than one, one or more of the following implementations in the present disclosure, but not limited to, may be applied.

In some implementations, in a DCI format, a DCI field for indicating at least one TCI state (e.g., a TCI field) may indicate a first DL/UL/joint TCI state index and/or a second DL/UL/joint TCI state index from multiple configured TCI state indices or multiple activated TCI state indices. In some implementations, in a DCI format, a DCI field for selecting at least one TCI state (e.g., a TCI selection field) may indicate the applied first TCI state, the applied second TCI state, or both of the applied first TCI state and second TCI state from the indicated TCI state indices via the DCI field for indicating at least one TCI state to the scheduled/activated DL reception or UL transmission. In some implementations, the UE may receive the DCI including a DCI filed for indicating at least one TCI state (e.g., a TCI field) and another DCI field for selecting at least one TCI state (e.g., a TCI selection field). In some implementations, a default TCI selection indication may be a default beam indication that the UE applies to the scheduled/activated DL reception/UL transmission when the TCI selection field is absent. In some implementations, a DCI field for indicating at least one TCI state (e.g., a TCI field) and a DCI field for selecting at least one TCI state (e.g., a TCI selection field) may be in the same DCI format or in different DCI formats.

When a timing offset between the reception of the scheduling DCI and the scheduled/activated PDSCH reception is less than a threshold, one or more of the following implementations in the present disclosure, but not limited to, may be applied. When a timing offset between the reception of the scheduling DCI and the scheduled/activated PDSCH reception is equal to or larger than a threshold, one or more of the following implementations in the present disclosure, but not limited to, may be applied. When a timing offset between the reception of the scheduling DCI and the scheduled/activated PUSCH transmission is less than a threshold, one or more of the following implementations in the present disclosure, but not limited to, may be applied. When a timing offset between the reception of the scheduling DCI and the scheduled/activated PUSCH transmission is equal to or larger than a threshold, one or more of the following implementations in the present disclosure, but not limited to, may be applied. When a UE supports two default beams in FR2, one or more of the following implementations in the present disclosure, but not limited to, may be applied. When a UE does not support two default beams in FR2, one or more of the following implementations in the present disclosure, but not limited to, may be applied. When a UE operates in FR1, one or more of the following implementations in the present disclosure, but not limited to, may be applied.

In some implementations, a DL reception may include a PDCCH, a PDSCH, an SPS PDSCH, a CSI-RS, a DM-RS, and/or a PT-RS. In some implementations, a DL reception may include a set of PDCCH repetitions, a set of PDSCH repetitions, a set of SPS PDSCH repetitions, and/or a set of CSI-RS repetitions. In some implementations, a UL transmission may include a PUCCH, a PUSCH, a configured grant PUSCH, and/or an SRS. In some implementations, a UL transmission may include a set of PUCCH repetitions, a set of PUSCH repetitions, a set of configured grant PUSCH repetitions, and/or a set of SRS repetitions.

When a DCI format 0_0 or a DCI format 1_0 is used to schedule a UL transmission or a DL reception, one or more of the following implementations in the present disclosure, but not limited to, may be applied. When a DCI format 0_0 or a DCI format 1_0 is used to update the beam information, one or more of the following implementations in the present disclosure, but not limited to, may be applied.

In some implementations, different channels/resources/reference signals corresponding to the same TRP/panel may mean that the different channels/resources correspond to the same SRI, the same SRS resource set, the same Transmission Precoding Matrix Indicator (TPMI), the same DL TCI state, the same UL TCI state, the same CORESETPoolIndex, the same CORESET, the same CORESET group, the same TCI configuration, the same power control parameter, the same spatial relation information, the same search space, the same search space group, the same CSI-RS resource configuration, the same DM-RS resource configuration, the same SRS resource configuration, the same reference signal indication, the same panel indication, and/or the same joint TCI state.

In some implementations, there may be no explicit indication for the TRP information, and a default beam may be determined based on a (pre-) configured/(pre-) determined rule. In some implementations, the TCI configuration may include, but is not limited to, the unified TCI state type, the joint TCI state, the UL TCI state, and/or the DL TCI state. In some implementations, the TCI configuration may include the RRC parameters which include lists for adding or releasing the TCI states. In some implementations, the TCI configuration may correspond to any scheduling configuration (e.g., the PDSCH-Config, the PUSCH-Config, the PUCCH-Config, the PUCCH-ConfigurationList, and/or the PDCCH-Config). In some implementations, the TCI configuration may include any TCI information (e.g., the TCI state index, the QCL type, the unified TCI framework triggering, and/or the multi-TRP scheme).

In some implementations, different channels/resources/reference signals corresponding to the same TRP/panel may mean that the channels/resources/reference signals are used with the same spatial domain filter/setting for a reception of an SS/PBCH block. The UE may apply the same parameters for determining the same spatial domain filter for the different channels/resources/reference signals corresponding to the same TRP/panel. For example, the same parameters may be included in the TCI state. In some implementations, different channels/resources/reference signals corresponding to the same TRP/panel may mean that the channels/resources/reference signals are associated with the QCL assumption providing the same reference signal.

In some implementations, different channels/resources/reference signals corresponding to the same TRP/panel may mean that the channels/resources/reference signals are used with a same spatial domain filter/setting for a reception of a periodic/semi-persistent/aperiodic CSI-RS resource. The UE may apply the same parameters for determining the same spatial domain filter for the different channels/resources/reference signals corresponding to the same TRP/panel. For example, the same parameters may be included in the TCI state. In some implementations, different channels/resources/reference signals corresponding to the same TRP/panel may mean that the channels/resources/reference signals are indicated to be applied a same spatial TX/RX domain filter/setting to transmit/receive to/from the corresponding TRP/panel.

In some implementations, different channels/resources/reference signals corresponding to the same TRP/panel may mean that the channels/resources/reference signals are used with the same spatial domain filter/setting for a transmission of an SRS. The SRS resource may be allocated for one of the following purposes: beam management, codebook-based channel sounding, non-codebook-based channel sounding, and antenna switching. In some implementations, the SRS resource may be allocated for the beam management. In some implementations, different channels/resources corresponding to the same TRP/panel may mean that the channels/resources/reference signals are used with the same spatial domain filter/setting for PDCCH receptions corresponding to the same CORESET ID or the same CORESET group.

In some implementations, different channels/resources corresponding to the same TRP/panel may mean that the channels/resources/reference signals are used with the same spatial domain filter/setting for PDCCH receptions with associated CORESET index(es) corresponding to the same CORESET pool index. In some implementations, different channels/resources corresponding to the same TRP/panel may mean that the channels/resources/reference signals are indicated to the same set of power control parameters. In some implementations, the power control parameters may include, but not limited to, the pathloss RS, the Transmit Power Control (TPC) command, the PO value, the alpha value, and/or the close loop index. In some implementations, different channels/resources corresponding to the same TRP/panel may mean that the channels/resources/reference signals are associated with the same BFD RS set.

In some implementations, the at least one unified indication may include a common DL beam indication, a common UL beam indication, and/or a joint DL/UL beam indication. Specifically, the beam indication may include the TRP/panel indication.

In some implementations, the common DL beam indication (or the separate DL beam indication) may correspond to the same DL TCI state, the same information of QCL assumption, the same CORESET index, the same CORESET pool index, the same search space index, the same search space group index, the same group index, the same RS index, the same BFD RS index/set, and/or the same DLorJoint TCI state index. In some implementations, the common UL beam indication (or the separate UL beam indication) may correspond to the same UL TCI state, the same SRS resource set, the same spatial relation information, the same power control set, the same CORESET index, the same CORESET pool index, the same search space index, the same search space group index, the same group index, the same RS index, and/or the same DLorJoint TCI state index. In some implementations, the joint DL/UL beam indication may correspond to the same group index, and/or same DLorJoint TCI state index.

In some implementations, the unified indication may indicate multiple activated/configured TCI states. The activated/configured TCI states may correspond to a group specific to the unified TCI framework. The UE may receive the unified indication via an RRC message, a MAC CE, and/or the DCI from the serving cell. The serving cell may include a PCell, a PSCell, an SPcell, an SCell, and/or a cell with a PCI which is different from the PCell. In some implementations, the reference unified TCI state may be used to provide an applicable TCI state based on a reference BWP of a reference serving cell when the TCI state is not present in a BWP of a serving cell. It should be noted that the reference unified TCI state(s) may include a DL TCI state, a UL TCI state, a joint TCI state, a list of DL TCI states, a list of UL TCI states, or a list of joint TCI states.

In some implementations, the RRC signaling from a gNB/NW may enable or disable a default beam indication. For example, a UE may receive an RRC parameter used to indicate whether the default beam indication is enabled or not. If the RRC parameter is set to ‘enabled’, the UE may perform the default beam indication. Otherwise, the UE may not perform the default beam indication. In some implementations, the RRC signaling may configure at least one default TCI state. For example, if a UE receives the configuration of at least one default TCI state by the RRC signaling, and the UE is not indicated any TCI states by the DCI and/or the MAC CE, the UE may apply the at least one default TCI state for the DL reception and/or the UL transmission.

In some implementations, the RRC signaling may configure the association between the TCI state and the scheduled DL reception or the UL transmission for a default beam indication. In some implementations, the RRC signaling may configure the separate TCI states (e.g., a first TCI state and a second TCI state) corresponding to different TRPs for the default indication. In some implementations, the RRC signaling may configure the separate TCI states corresponding to different cells for the default indication. In some implementations, at least one default threshold value may be configured via the RRC signaling. In some implementations, the RRC signaling may configure how the UE should apply the default TCI selection indication when at least one DCI field for indicating the TCI selection is absent.

In some implementations, a MAC CE may activate or deactivate at least one default TCI state. In some implementations, a MAC CE may activate or deactivate a default indication. In some implementations, a MAC CE may activate or deactivate a default threshold value.

In some implementations, if a DCI field for selecting at least one TCI state exists, the DCI field for indicating at least one TCI state may not be expected to be absent. In some implementations, if the DCI schedules a DL reception or a UL transmission without the TCI field, the TCI selection field may indicate at least one TCI state activated by the MAC CE. In some implementations, if the DCI schedules a DL reception or a UL transmission without the TCI field, the TCI selection field may indicate at least one TCI state configured by the RRC signaling. In some implementations, the TCI selection field may indicate the order of the applied TCI state(s) from at least one default TCI state. In some implementations, the DCI may include the DCI format 1_0, the DCI format 1_1, the DCI format 1_2, the DCI format 0_0, the DCI format 0_1, the DCI format 0_2, and/or the DCI format for the beam indication.

In some implementations, a UE may receive, from a BS, an RRC message, a MAC CE, and/or DCI that includes at least one beam indication to indicate the beam information. In some implementations, a UE may apply the indicated beam information to the received DL receptions, transmitted UL transmissions, the DL receptions to be received, and/or the UL transmissions to be transmitted. In some implementations, a UE may apply the first TCI state index, or the first x TCI state indices activated by the MAC CE (e.g., x may be equal to 2, 3, or 4) to the scheduled DL reception or the scheduled UL transmission. In some implementations, a UE may apply the first TCI state index, or the first x TCI state indices configured by the RRC signaling (e.g., x may be equal to 2, 3, or 4) to the scheduled DL reception or the scheduled UL transmission. In some implementations, a UE may report, to the BS, its capability to inform the support of the default indication in the unified TCI framework. In some implementations, a UE may report, to the BS, its capability of supporting two default beams for S-DCI-based MTRP in FR2 regardless of the threshold.

In some implementations, a BS may transmit, to a UE, an RRC message, a MAC CE, and/or DCI that includes at least one beam indication to indicate the beam information. In some implementations, a BS may receive a transmission from a UE based on the indicated beam information. In some implementations, a BS may transmit, to the UE, the DCI to schedule a DL reception and/or a UL transmission. In some implementations, a BS may configure the TCI field and the TCI selection field simultaneously (e.g., in an RRC message). In some implementations, a BS may receive, from the UE, the UE capability indicating the support of the default indication in the unified TCI framework. In some implementations, a BS may receive, from the UE, the UE capability indicating the support of two default beams for the S-DCI-based MTRP in FR2 regardless of the threshold.

In some implementations, the RRC signaling may enable or disable a default indication. For example, the RRC signaling may include a parameter (e.g., a default indication in a format of ENUMERATED {enabled}) that is when set to ‘enabled’, it may mean that the default indication is enabled. If the parameter is absent, the default indication may be disabled.

In some implementations, if the default indication is enabled, the UE may apply the TCI state with the lowest index as the first TCI state indicated by the TCI selection field. It should be noted that the TCI states may be configured by the RRC signaling and/or may be activated by the MAC CE. The TCI state with the lowest index may include the TCI state with the lowest index in the TCI state list configured by the RRC signaling and/or the TCI state with the lowest index in a codepoint included in the MAC CE.

In some implementations, if the default indication is enabled, the UE may apply the TCI state with the x lowest index (e.g., x may be equal to 2, 3, or 4) as the x-th indicated TCI state by the TCI selection field. For example, if the TCI states with indices 1, 3, 5, and 7 are configured, the first applied TCI state may be the TCI state with index 1, the second applied TCI state may be the TCI state with index 3, or both the TCI state with index 1 and the TCI state with index 3 may be applied simultaneously. In some implementations, the UE may be configured with a multi-TRP operation.

In some implementations, the TCI state may include a set of TCI states configured by the RRC signaling. In some implementations, the TCI state may include a set of TCI states activated by the MAC CE. In some implementations, the TCI state may include the TCI state of a CORESET where the DCI is detected.

In some implementations, if the default indication is disabled, the UE may expect that the TCI field in an RRC configuration, in a MAC CE, or in a DCI field is present. The TCI field may indicate only one DL/UL/joint TCI state to the UE. The TCI field may indicate one or two DL/UL/joint TCI states to the UE. The TCI state indicated by the TCI field may apply to a DL reception or a UL transmission.

In some implementations, if the default indication is disabled, the UE may expect that the number of configured TCI states is one for a single TRP operation. In some implementations, if the default indication is disabled, the UE may expect that the number of configured TCI states is two or more for a multiple TRP operation. In some implementations, if the default indication is disabled, the UE may expect that the number of activated TCI states is one for a single TRP operation. In some implementations, if the default indication is disabled, the UE may expect that the number of activated TCI states is two for a multiple TRP operation. In some implementations, if the default indication is disabled, the UE may expect that the timing offset between the reception of the scheduling DCI and the scheduled/activated DL reception or the scheduled/activated UL transmission is equal to or larger than a threshold.

In some implementations, the RRC signaling may configure at least one default TCI state. In some implementations, an RRC parameter may be used to configure the at least one default TCI state. In some implementations, an RRC configuration may be used to configure the default TCI state. In some implementations, the at least one default TCI state may correspond to a default DL TCI state, a default UL TCI state, and/or a default joint TCI state.

In some implementations, the RRC signaling may configure the association between the TCI state and the scheduled DL reception or the scheduled UL transmission for the default indication. In some implementations, the at least one default TCI state may be configured in a PDSCH configuration, an SPS PDSCH configuration, a CORESET configuration, a search space configuration, a PUCCH configuration, a PUSCH configuration, a configured grant configuration, a DL BWP configuration, a UL BWP configuration, a serving cell configuration, a cell group configuration, and/or a TCI state configuration. In some implementations, the RRC signaling may configure the default TCI state for each DL reception or each UL transmission. In some implementations, the RRC configuration may configure whether the first one of the at least one TCI state, the second one of the at least one TCI state, or both of the first one and the second one of the at least one TCI state is applied to the scheduled/activated DL reception or the scheduled/activated UL transmission.

In some implementations, the RRC signaling may configure the separate TCI states (e.g., a first TCI state and a second TCI state) corresponding to different TRPs for the default indication. In some implementations, for an mTRP operation, a first default TCI state may be present and a second default TCI state may be absent. In some implementations, a first default TCI state may be absent and a second default TCI state may be present. In some implementations, the RRC signaling may configure a default TCI state selection rule for a first TRP and configure a default TCI state selection rule for a second TRP.

In some implementations, when a default TCI state selection rule for a first TRP is configured, the UE may apply the TCI state with the lowest index, among the configured/activated/indicated TCI states, via the RRC signaling/MAC CE/DCI field associated with the first TRP, as the first default TCI state. When a default TCI state selection rule for a second TRP is configured, the UE may apply the TCI state with the lowest index, among the configured/activated/indicated TCI states, via the RRC signaling/MAC CE/DCI field associated with the second TRP, as the second default TCI state.

In some implementations, when a default TCI state selection rule for a first TRP is configured, the UE may apply the TCI state with the lowest index, among the configured default TCI states, for the first TRP, as the first default TCI state. When a default TCI state selection rule for a second TRP is configured, the UE may apply the TCI state with the lowest index, among the configured default TCI states, for the second TRP, as the second default TCI state.

In some implementations, when a default TCI state selection rule for a first TRP is configured, the UE may apply the first TCI state of the indicated TCI states via the TCI field for the first TRP, as the first default TCI state. When a default TCI state selection rule for a second TRP is configured, the UE may apply the second TCI state of the indicated TCI states via the TCI field for the second TRP, as the second default TCI state. In some implementations, the RRC signaling may configure a set of default TCI states for a first TRP and configure a set of default TCI states for a second TRP.

In some implementations, the RRC signaling may configure the separate TCI states corresponding to different cells for the default indication. In some implementations, for inter-cell beam management, inter-cell mobility operation, or LTM, a first default TCI state may be present, and a second default TCI state may be absent. In some implementations, a first default TCI state may be absent and a second default TCI state may be present. For example, the first default TCI state may correspond to the source serving cell, while the second default TCI state may correspond to a cell different from the serving cell (e.g., a candidate target cell or a selected target cell). In some implementations, the RRC signaling may configure a default TCI state selection rule for a serving cell and configure a default TCI state selection rule for a cell which is different from the serving cell. In some implementations, the RRC signaling may configure a set of default TCI states for a serving cell and configure a set of default TCI states for a cell which is different from the serving cell.

In some implementations, at least one default timing offset threshold value may be configured by the RRC signaling. In some implementations, the timing offset may include the beam application time.

In some implementations, the threshold values related to the timing offset between the scheduling DCI and the scheduled/activated DL reception/UL transmission for a determination of whether the UE applies the default TCI state for different TRPs may be different. The threshold value may be configured per TRP/TCI configuration. More specifically, in some implementations, the beam application time for the first TCI state and the second TCI state may be different.

In some implementations, the threshold values related to the timing offset between the scheduling DCI and the scheduled/activated DL reception/UL transmission for a determination of whether the UE applies the default TCI state for different channels/RSs may be different. The threshold value may be configured per channel/RS configuration.

In some implementations, the threshold values related to the timing offset between the scheduling DCI and the scheduled/activated DL reception/UL transmission for a determination of whether the UE applies the default TCI state for different cells may be different. The threshold value may be configured per cell.

In some implementations, the threshold values related to the timing offset between the scheduling DCI and the scheduled/activated DL reception/UL transmission for a determination of whether the UE applies the default TCI state for different BWPs may be different. The threshold value may be configured per BWP.

In some implementations, an RRC configuration may configure, to the UE, the first DL/UL/joint TCI state, the second DL/UL/joint TCI state, or both the first and second DL/UL/joint TCI states from multiple TCI states indicated by the RRC signaling, a MAC CE, or a DCI field to inform which indicated TCI state is applied to the scheduled/activated DL reception/UL transmission. For example, when an RRC configuration configures ‘first’ to the UE, the UE may apply the first DL/UL/joint TCI state from two indicated TCI states associated with two TRPs to the scheduled/activated DL reception or the scheduled/activated UL transmission.

In some implementations, the RRC signaling may configure how a TCI state should be applied (e.g., by the UE) to a DL reception or a UL transmission when at least one DCI field (e.g., TCI selection field) for indicating the TCI selection is absent. In some implementations, the RRC signaling may configure which one of following implementations 1-5 should be applied to indicate the TCI selection.
Implementation 1: An RRC configuration for informing which TCI state may be applied to the scheduled/activated DL reception or the scheduled/activated UL transmission.
Implementation 2: A UE may always apply the first one of the at least one TCI state indicated by the TCI field.
Implementation 3: A UE may always apply all the TCI states indicated by the TCI field.
Implementation 4: A UE may apply the TCI state that has been applied to the PDCCH with the scheduling/activation DCI.
Implementation 5: A UE may apply the TCI state indicated by the TCI field of the most recently applied beam indication DCI.

For example, the RRC signaling may include a parameter in a format of ENUMERATED {Implementation 1, Implementation 2, Implementation 3, Implementation 4, Implementation 5, spare1, spare2, spare3}. If the parameter is indicated to be “Implementation 1”, the UE may apply the configured TCI state to the scheduled/activated DL reception or UL transmission. If the parameter is indicated to be “Implementation 2”, the UE may always apply the first TCI state of the at least one TCI state which is indicated by the TCI field.

In some implementations, the RRC signaling may configure whether an RRC configuration for informing which TCI state is applied to the scheduled/activated DL reception or the scheduled/activated UL transmission is present. The RRC signaling may enable and disable the RRC configuration.

In some implementations, the RRC signaling may configure whether the first one of the at least one indicated TCI state is applied to the scheduled/activated DL reception or the scheduled/activated UL transmission. The RRC signaling may use ‘first’ and ‘second’ to indicate the applied TCI state. For example, the RRC signaling may be in a format of ENUMERATED {first, second}.

In some implementations, the RRC signaling may configure whether all indicated TCI states are applied to the scheduled/activated DL reception or the scheduled/activated UL transmission. The RRC signaling may use ‘both’ or ‘all’ to indicate the applied TCI state. For example, the RRC signaling may be in a format of ENUMERATED {both} or {all}.

In some implementations, the RRC signaling may configure whether the first one of the at least one indicated TCI state, the second one of the at least one indicated TCI state, and/or all indicated TCI states is applied to the scheduled/activated DL reception or the scheduled/activated UL transmission. The RRC signaling may use ‘first’, ‘second’, or ‘both/all’ to indicate the applied TCI state. For example, the RRC signaling may be in a format of ENUMERATED {first, second, both/all, spare}.

In some implementations, the RRC signaling may configure whether to apply the same TCI state that is applied to the PDCCH reception with the scheduling/activation DCI to the scheduled/activated DL reception or the scheduled/activated UL transmission. The RRC signaling may use ‘follow’ to enable applying the same TCI state that is applied to the PDCCH reception with the scheduling/activation DCI. For example, the RRC signaling may be in a format of ENUMERATED {follow}.

In some implementations, the RRC signaling may configure whether to apply the TCI state indicated by the TCI field of the most recently applied beam indication DCI. If the RRC signaling only configures the presence of the TCI field, the UE may apply the first of the TCI states indicated by the TCI field to the scheduled/activated DL reception or the scheduled/activated UL transmission.

In some implementations, if the RRC signaling is absent, the UE may not expect to be configured/activated with more than one TCI state. In some implementations, if the RRC signaling is absent, the UE may apply the TCI state with the lowest index of the TCI states indicated by the TCI field to the scheduled/activated DL reception or the scheduled/activated UL transmission. In some implementations, if the RRC signaling is absent, selection of the TCI state that should be applied to the scheduled/activated DL reception, or the scheduled/activated UL transmission, is up to the UE's implementation.

In some implementations, a MAC CE may activate or deactivate at least one default TCI state. In some implementations, the at least one default TCI state may include a TCI state, or a list of TCI states configured by an RRC configuration. In some implementations, the MAC CE field may indicate whether to activate the default TCI state. In some implementations, a MAC CE field with a value of ‘1’ may be used to activate the default TCI state. In some implementations, a MAC CE field with a value of ‘0’ may be used to deactivate the default TCI state. In some implementations, the MAC CE field may indicate the TCI state index of the default TCI. For example, the MAC CE field with a TCI state index associated with the default TCI state may be used to activate the default TCI state.

In some implementations, a MAC CE field may activate the TCI state in a particular order. In some implementations, the MAC CE field may activate the first DL/UL/joint TCI state of the configured DL/UL/joint TCI states. In some implementations, the MAC CE field may activate the second DL/UL/joint TCI state of the configured DL/UL/joint TCI states. In some implementations, the MAC CE field may activate both the first and the second DL/UL/joint TCI states of the configured DL/UL/joint TCI states. In some implementations, the MAC CE field may activate more than two DL/UL/joint TCI states of the configured DL/UL/joint TCI states.

In some implementations, a MAC CE may activate or deactivate a default indication. In some implementations, the default indication may include a beam indication from the RRC configuration or from the CORESET association. In some implementation, the MAC CE may indicate whether to follow the TCI state of the PDCCH with the scheduling/activation DCI. For example, the MAC CE field with value ‘1’ may indicate to the UE to follow the same TCI state of the PDCCH with the scheduling/activation DCI to the scheduled/activated DL reception/UL transmission. For example, the MAC CE field with value ‘0’ may indicate to the UE not to follow the same TCI state of the PDCCH with the scheduling/activation DCI to the scheduled/activated DL reception/UL transmission.

In some implementations, the MAC CE may indicate to the UE to follow the configured TCI state. For example, the MAC CE field with value ‘1’ may indicate to the UE to follow the configured TCI state specific to the default indication to the scheduled/activated DL reception/UL transmission. For example, the MAC CE field with value ‘0’ may indicate to the UE not to follow the configured TCI state specific to the default indication to the scheduled/activated DL reception/UL transmission. For example, the MAC CE field with a TCI state index may indicate to the UE not to follow the configured TCI state specific to the default indication to the scheduled/activated DL reception/UL transmission and apply the TCI state in the MAC CE field to the scheduled/activated DL reception/UL transmission.

In some implementations, a MAC CE may activate or deactivate a default threshold value for determining whether the UE should apply the default indication. In some implementations, the MAC CE field may be used to indicate at least one threshold value for each TRP. For example, the MAC CE field may include an index to indicate which configured threshold value from the RRC configuration is applied. The MAC CE field with value ‘O’ may indicate that the first threshold value from a list of threshold values in the RRC configuration is applied.

In some implementations, in a DCI format or in different DCI, if a DCI field for selecting at least one TCI state exists, a DCI field for indicating at least one TCI state is not expected to be absent. In some implementations, if the DCI schedules a DL reception or a UL transmission without the TCI field used to indicate at least one TCI state to a UE, the TCI selection field may indicate at least one TCI state activated by the MAC CE.

In some implementations, the codepoint ‘00’ of the TCI selection field may indicate the TCI state with the first lowest index in the MAC CE. In some implementations, the codepoint ‘00’ of the TCI selection field may indicate the TCI state corresponding to the first lowest ordinal position of the TCI state in the MAC CE. In some implementations, the codepoint ‘01’ of the TCI selection field may indicate the TCI state with the second lowest index in the MAC CE. In some implementations, the codepoint ‘01’ of the TCI selection field may indicate the TCI state with the second lowest ordinal position of the TCI state in the MAC CE. In some implementations, the codepoint ‘10’ of the TCI selection field may indicate the TCI state with the first two lowest indices in the MAC CE. In some implementations, the codepoint ‘10’ of the TCI selection field may indicate the TCI state with the first two lowest ordinal position of the TCI states in the MAC CE. In some implementations, the codepoint ‘11’ of the TCI selection field may indicate the switching of the applied TCI state from the indicated TCI states in the MAC CE. For example, the TCI state with the first lowest index in the MAC CE may correspond to the second indicated TCI state of the TCI selection field, and the TCI state with the second lowest index in the MAC CE may correspond to the first indicated TCI state of the TCI selection field.

In some implementations, in a DCI format or in different DCI, if the DCI schedules a DL reception or a UL transmission without the TCI field used to indicate at least one TCI state to a UE, the TCI selection field may indicate at least one TCI state configured by the RRC signaling. In some implementations, the codepoint ‘00’ of the TCI selection field may indicate the TCI state with the first lowest index configured in the RRC configuration. In some implementations, the codepoint ‘01’ of the TCI selection field may indicate the TCI state with the second lowest index configured in the RRC configuration. In some implementations, the codepoint ‘10’ of the TCI selection field may indicate the TCI state with the first two lowest indices configured in the RRC configuration. In some implementations, the codepoint ‘11’ of the TCI selection field may indicate the switching of the applied TCI state from the indicated TCI states in the RRC configuration. For example, the TCI state with the first lowest index in the RRC configuration may correspond to the second indicated TCI state of the TCI selection field, and the TCI state with the second lowest index in the RRC configuration may correspond to the first indicated TCI state of the TCI selection field.

In some implementations, the TCI selection field may indicate the order of the applied TCI state(s) from at least one default TCI state. In some implementations, the codepoint ‘00’ of the TCI selection field may indicate the first default TCI state. In some implementations, the codepoint ‘01’ of the TCI selection field may indicate the second default TCI state. In some implementations, the codepoint ‘10’ of the TCI selection field may indicate both the first and the second default TCI states. In some implementations, the codepoint ‘11’ of the TCI selection field may switch the order of the indicated default TCI states. In some implementations, the DCI may include the DCI format 1_0, the DCI format 1_1, the DCI format 1_2, the DCI format 0_0, the DCI format 0_1, the DCI format 0_2, and/or the DCI format for the beam indication.

In some implementations, a UE may receive, from a BS, an RRC message, a MAC CE, and/or DCI that includes at least one beam indication to indicate the beam information. In some implementations, a UE may apply the indicated beam information to the received/activated DL receptions, transmitted/activated UL transmissions, the DL receptions to be received, and/or the UL transmissions to be transmitted. In some implementations, a UE may apply the first TCI state index, or the first x TCI state indices activated by the MAC CE (e.g., x may be equal to 2, 3, or 4) to the scheduled/activated DL reception or the scheduled/activated UL transmission. In some implementations, a UE may apply the first TCI state index, or the first x TCI state indices configured by the RRC signaling (e.g., x may be equal to 2, 3, or 4) to the scheduled/activated DL reception or the scheduled/activated UL transmission.

In some implementations, a UE may report its capability to inform the support of the default indication in the unified TCI framework. In some implementations, the UE capability may correspond to enabling the default beam indication. In some implementations, the UE capability may correspond to a threshold value. In some implementations, the UE capability may correspond to the number of the supported beam indications.

In some implementations, a BS may transmit, to a UE, an RRC message, a MAC CE, and/or DCI that includes at least one beam indication to indicate the beam information. In some implementations, a BS may receive a transmission from a UE based on the indicated beam information. In some implementations, a BS may transmit DCI to schedule a DL reception and/or a UL transmission. In some implementations, a BS may configure the TCI field and the TCI selection field simultaneously. In some implementations, the TCI field may correspond to a first RRC parameter in an RRC configuration and the TCI selection field may correspond to a second RRC parameter in an RRC configuration. In some implementations, it may be up to the gNB's implementation to determine how to apply the TCI state to the UE.

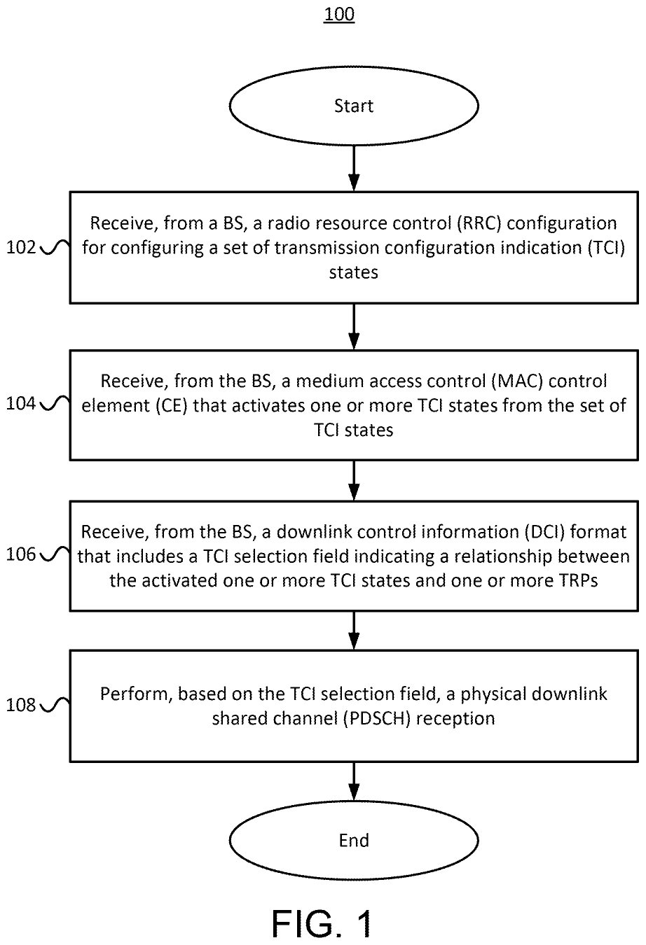

FIG. 1 is a flowchart/process 100 illustrating a method performed by a UE for beam indication in an mTRP operation, according to an example implementation of the present disclosure.

Process 100 may start, in action 102, by the UE receiving, from a BS, a radio resource control (RRC) configuration for configuring a set of transmission configuration indication (TCI) states. In some implementations, each TCI state of the set of TCI states may include a joint TCI state. In some implementations, each TCI state of the set of TCI states may include a downlink (DL) TCI state.

In action 104, the UE may receive, from the BS, a medium access control (MAC) control element (CE) that activates one or more TCI states from the set of TCI states.

In action 106, the UE may receive, from the BS, a downlink control information (DCI) format that includes a TCI selection field indicating a relationship between the activated one or more TCI states and one or more TRPs. In some implementations, the DCI format may include a DCI format 1_1 or a DCI format 1_2.

In some implementations, in a case that the DCI format does not further include a TCI field indicating one or more TCI states from the activated one or more TCI states, the TCI selection field may further indicate that the activated one or more TCI states may correspond to a first TRP, a second TRP, or both the first TRP and the second TRP.

In some implementations, the TCI selection field may include a first codepoint, a second codepoint, or a third codepoint. The first codepoint may indicate that a first activated TCI state of the activated one or more TCI states corresponds to a first TRP, and the first activated TCI state may have a lowest index among indices of the activated one or more TCI states. The second codepoint may indicate that a second activated TCI state of the activated one or more TCI states corresponds to a second TRP, and the second activated TCI state may have a second lowest index among indices of the activated one or more TCI states. The third codepoint may indicate that the first activated TCI state and the second activated TCI state of the activated one or more TCI states correspond, respectively, to the first TRP and the second TRP.

In some implementations, in a case that the DCI format further includes a TCI field indicating one or more TCI states from the activated one or more TCI states, the TCI selection field may further indicate that the indicated one or more TCI states correspond to a first TRP, a second TRP, or both the first TRP and the second TRP.

In action 108, the UE may perform, based on the TCI selection field, a physical downlink shared channel (PDSCH) reception. The process may then end.

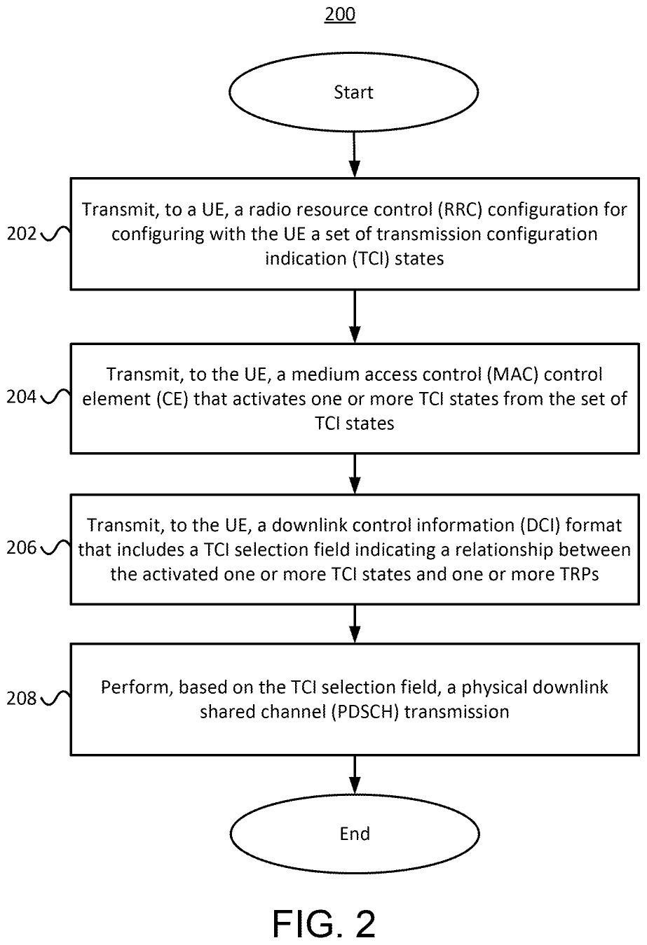

FIG. 2 is a flowchart/process 200 illustrating a method performed by a BS for beam indication in an mTRP operation, according to an example implementation of the present disclosure.

Process 200 may start, in action 202, by the BS transmitting, to a UE, a radio resource control (RRC) configuration for configuring with the UE a set of transmission configuration indication (TCI) states. In some implementations, each TCI state of the set of TCI states may include a joint TCI state. In some implementations, each TCI state of the set of TCI states may include a downlink (DL) TCI state.

In action 204, the BS may transmit, to the UE, a medium access control (MAC) control element (CE) that activates one or more TCI states from the set of TCI states.

In action 206, the BS may transmit, to the UE, a downlink control information (DCI) format that includes a TCI selection field indicating a relationship between the activated one or more TCI states and one or more TRPs. In some implementations, the DCI format may include a DCI format 1_1 or a DCI format 1_2.

In some implementations, in a case that the DCI format does not further include a TCI field indicating one or more TCI states from the activated one or more TCI states, the TCI selection field may further indicate that the activated one or more TCI states correspond to a first TRP, a second TRP, or both the first TRP and the second TRP.

In some implementations, the TCI selection field may include a first codepoint, a second codepoint, or a third codepoint. The first codepoint may indicate that a first activated TCI state of the activated one or more TCI states corresponds to a first TRP, and the first activated TCI state may have a lowest index among indices of the activated one or more TCI states. The second codepoint may indicate that a second activated TCI state of the activated one or more TCI states corresponds to a second TRP, and the second activated TCI state may have a second lowest index among indices of the activated one or more TCI states. The third codepoint may indicate that the first activated TCI state and the second activated TCI state of the activated one or more TCI states correspond, respectively, to the first TRP and the second TRP.

In some implementations, in a case that the DCI format further includes a TCI field indicating one or more TCI states from the activated one or more TCI states, the TCI selection field may further indicate that the indicated one or more TCI states correspond to a first TRP, a second TRP, or both the first TRP and the second TRP.

In action 208, the BS may perform, based on the TCI selection field, a physical downlink shared channel (PDSCH) transmission. The process may then end.

The technical problem addressed by the present disclosure is how to ensure accurate beam selection and alignment in mTRP operations by allowing a UE to understand the specific TCI states that are currently active and how these states relate to different TRPs. The present disclosure enables the UE to adapt its beamforming strategies according to the precise configurations of the network, leading to an advantageous technical effect of improved signal quality, reduced interference, and enhanced overall network performance by ensuring the UE aligns with the most appropriate beam(s) for its current situation.

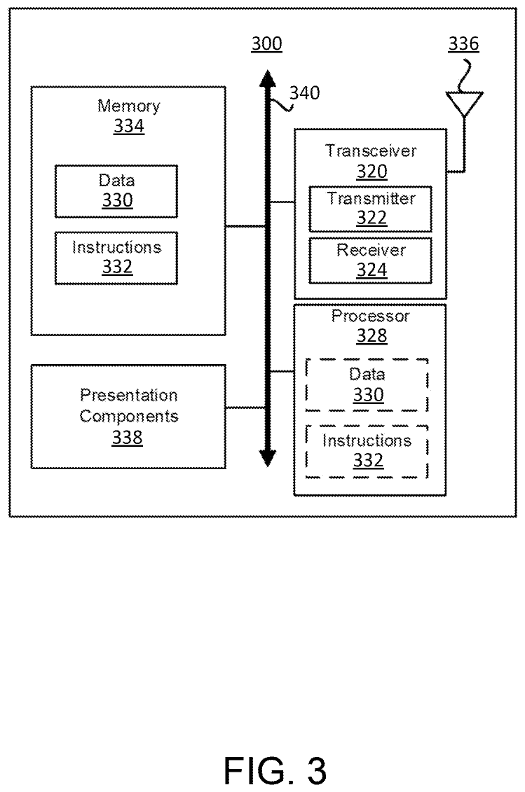

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 and 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 and 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for beam indication in a multiple transmission and reception point (mTRP) operation, the method comprising:
receiving, from a base station (BS), a radio resource control (RRC) configuration for configuring a set of transmission configuration indication (TCI) states;
receiving, from the BS, a medium access control (MAC) control element (CE) that activates one or more TCI states from the set of TCI states;
receiving, from the BS, a downlink control information (DCI) format that includes a TCI selection field indicating a relationship between the activated one or more TCI states and one or more TRPs; and
performing, based on the TCI selection field, a physical downlink shared channel (PDSCH) reception.

2. The method of claim 1, wherein in a case that the DCI format does not further include a TCI field indicating one or more TCI states from the activated one or more TCI states, the TCI selection field further indicates that the activated one or more TCI states correspond to a first TRP, a second TRP, or both the first TRP and the second TRP.

3. The method of claim 1, wherein:
the TCI selection field includes a first codepoint, a second codepoint, or a third codepoint,
the first codepoint indicates that a first activated TCI state of the activated one or more TCI states corresponds to a first TRP,
the first activated TCI state has a lowest index among indices of the activated one or more TCI states,
the second codepoint indicates that a second activated TCI state of the activated one or more TCI states corresponds to a second TRP,
the second activated TCI state has a second lowest index among indices of the activated one or more TCI states, and
the third codepoint indicates that the first activated TCI state and the second activated TCI state of the activated one or more TCI states correspond, respectively, to the first TRP and the second TRP.

4. The method of claim 1, wherein in a case that the DCI format further includes a TCI field indicating one or more TCI states from the activated one or more TCI states, the TCI selection field further indicates that the indicated one or more TCI states correspond to a first TRP, a second TRP, or both the first TRP and the second TRP.

5. The method of claim 1, wherein each TCI state of the set of TCI states comprises a joint TCI state.

6. The method of claim 1, wherein each TCI state of the set of TCI states comprises a downlink (DL) TCI state.

7. The method of claim 1, wherein the DCI format comprises a DCI format 1_1 or a DCI format 1_2.

8. A user equipment (UE) for beam indication in a multiple transmission and reception point (mTRP) operation, the UE comprising:
one or more processors; and
at least one non-transitory computer-readable medium coupled to at least one of the one or more processors, and storing one or more computer-executable instructions that, when executed by the at least one of the one or more processors, cause the UE to:
receive, from a base station (BS), a radio resource control (RRC) configuration for configuring a set of transmission configuration indication (TCI) states;
receive, from the BS, a medium access control (MAC) control element (CE) that activates one or more TCI states from the set of TCI states;
receive, from the BS, a downlink control information (DCI) format that includes a TCI selection field indicating a relationship between the activated one or more TCI states and one or more TRPs; and
perform, based on the TCI selection field, a physical downlink shared channel (PDSCH) reception.

9. The UE of claim 8, wherein in a case that the DCI format does not further include a TCI field indicating one or more TCI states from the activated one or more TCI states, the TCI selection field further indicates that the activated one or more TCI states correspond to a first TRP, a second TRP, or both the first TRP and the second TRP.

10. The UE of claim 8, wherein:
the TCI selection field includes a first codepoint, a second codepoint, or a third codepoint,
the first codepoint indicates that a first activated TCI state of the activated one or more TCI states corresponds to a first TRP,
the first activated TCI state has a lowest index among indices of the activated one or more TCI states,
the second codepoint indicates that a second activated TCI state of the activated one or more TCI states corresponds to a second TRP,
the second activated TCI state has a second lowest index among indices of the activated one or more TCI states, and
the third codepoint indicates that the first activated TCI state and the second activated TCI state of the activated one or more TCI states correspond, respectively, to the first TRP and the second TRP.

11. The UE of claim 8, wherein in a case that the DCI format further includes a TCI field indicating one or more TCI states from the activated one or more TCI states, the TCI selection field further indicates that the indicated one or more TCI states correspond to a first TRP, a second TRP, or both the first TRP and the second TRP.

12. The UE of claim 8, wherein each TCI state of the set of TCI states comprises a joint TCI state.

13. The UE of claim 8, wherein each TCI state of the set of TCI states comprises a downlink (DL) TCI state.

14. The UE of claim 8, wherein the DCI format comprises a DCI format 1_1 or a DCI format 1_2.

15. A base station (BS) for beam indication in a multiple transmission and reception point (mTRP) operation, the BS comprising:
one or more processors; and
at least one non-transitory computer-readable medium coupled to at least one of the one or more processors, and storing one or more computer-executable instructions that, when executed by the at least one of the one or more processors, cause the BS to:
transmit, to a user equipment (UE), a radio resource control (RRC) configuration for configuring the UE with a set of transmission configuration indication (TCI) states;
transmit, to the UE, a medium access control (MAC) control element (CE) that activates one or more TCI states from the set of TCI states;
transmit, to the UE, a downlink control information (DCI) format that includes a TCI selection field indicating a relationship between the activated one or more TCI states and one or more TRPs; and
perform, based on the TCI selection field, a physical downlink shared channel (PDSCH) transmission.

16. The BS of claim 15, wherein in a case that the DCI format does not further include a TCI field indicating one or more TCI states from the activated one or more TCI states, the TCI selection field further indicates that the activated one or more TCI states correspond to a first TRP, a second TRP, or both the first TRP and the second TRP.

17. The BS of claim 15, wherein:
the TCI selection field includes a first codepoint, a second codepoint, or a third codepoint,
the first codepoint indicates that a first activated TCI state of the activated one or more TCI states corresponds to a first TRP,
the first activated TCI state has a lowest index among indices of the activated one or more TCI states,
the second codepoint indicates that a second activated TCI state of the activated one or more TCI states corresponds to a second TRP,
the second activated TCI state has a second lowest index among indices of the activated one or more TCI states, and
the third codepoint indicates that the first activated TCI state and the second activated TCI state of the activated one or more TCI states correspond, respectively, to the first TRP and the second TRP.

18. The BS of claim 15, wherein in a case that the DCI format further includes a TCI field indicating one or more TCI states from the activated one or more TCI states, the TCI selection field further indicates that the indicated one or more TCI states correspond to a first TRP, a second TRP, or both the first TRP and the second TRP.

19. The BS of claim 15, wherein each TCI state of the set of TCI states comprises a joint TCI state or a downlink (DL) TCI state.

20. The BS of claim 15, wherein the DCI format comprises a DCI format 1_1 or a DCI format 1_2.
